(19) United States
(12) Patent Application Publication
(10) Pub. No.: US 2025/0105574 A1
(43) Pub. Date: Mar. 27, 2025

(54) METHOD FOR ATTACHING A LABEL HOLDER TO AN ELECTRICALLY CONDUCTIVE WIRE, ENDLESS TAPE ANDCONTACT ARRANGEMENT

(71) Applicant: HARTING ELECTRIC STIFTUNG & CO. KG, Espelkamp (DE)

(72) Inventors: Luca BALTRUSCHAT, Minden (DE); Christof HERMONI, Rahden (DE); André BENEKE, Vechta (DE)

(21) Appl. No.: 18/687,614

(22) PCT Filed: Aug. 19, 2022
(86) PCT No.: PCT/DE2022/100621

§ 371 Date: Feb. 28, 2024

(30) Foreign Application Priority Data
Aug. 30, 2021 (DE) 10 2021 122 333.4

(51) Int. Cl. H01R 43/048; G09F 3/20; G09F 7/18; H01B 13/34; H01R 4/18; H01R 9/24

(52) U.S. Cl. CPC H01R 43/048; G09F 3/205; H01B 13/34; H01R 4/185; H01R 9/2475; G09F 2007/1839

(57) ABSTRACT

A method is provided for attaching a label holder to an end of an electrically conductive wire provided with a crimp contact wherein, before or during the crimping of the crimp contact onto the end of the wire, a fastening tab of the label holder composed of electrically insulating material is fastened to the crimp contact. An endless tape of label holders and a contact arrangement are also provided.

### BACKGROUND

### Technical Field

The present disclosure relates to a method for attaching a label holder to an end of an electrically conducting wire provided with a crimp contact, and to an endless tape of label holders and a contact arrangement.

### Description of the Related Art

Crimp contacts are often used to connect the stripped ends of electrically conducting wires to contacts of a plug connector. When a conductor bundle consisting or comprising of a plurality of wires is connected to a plug connector, it is often expedient to attach one label holder to each of the individual wires, the function of the respective wire and how the latter is to be correctly connected being able to be stated on the label holder.

Known label holders, for example in the form of a tag which has two eyelets, are fastened to a portion of the wire with the aid of a cable tie, for example.

In the context of the priority application pertaining to the present application, the German Patent and Trademark Office has researched the following prior art: JP H03-155086 A, JP H06-36143 U and WO 99/28918 A1.

### BRIEF SUMMARY

Embodiments of the disclosure provide a method to simplify the attachment of label holders to wires.

Embodiments provide that, before or during crimping of the crimp contact onto the end of the wire, a fastening tab of the label holder is fastened to the crimp contact, the fastening tab being composed of an electrically isolating material.

In one embodiment, the crimp contact may be utilized for fastening the label holder in such a way that the attachment of the label holder and the crimping of the crimp contact can take place efficiently in one operative step.

The fastening tab can be mechanically connected to the crimp contact in any manner known. If the label holder, or at least its fastening tab, is composed of plastics material, one or a plurality of rivets may be integrally molded on the fastening tab, for example, which engage in corresponding rivet holes of the crimp contact in such a way that a fixed connection between the label holder and the crimp contact can be established by compressing the rivets (e.g., by hot pressing). Since the crimp contacts are typically stamped parts, the rivet holes can be efficiently produced during stamping of the crimp contact.

In one embodiment, the fastening tab is positioned on the crimp contact in such a way that the fastening tab is crimped onto the end of the wire conjointly with the contact. The label holder and the wires in this instance are held together and fixedly connected to one another by the crimping. In some embodiments, the fastening tab may nevertheless be provided with rivets or other fastening means that initially enable provisional fastening before the final connection is then established during crimping.

An automatic crimping machine is often used for crimping the contacts, interlinked crimp contacts in the form of a contact tape being automatically supplied to said automatic crimping machine. In this case, the label holders can also be in the form of an endless tape which is mechanically unified with the contact tape before both tapes are conjointly supplied to the automatic crimping machine. The fastening of the label holders to the crimp contacts is simplified, and automating this process is facilitated as a result. Not only the connections between the successive crimp contacts are then severed in the automatic crimping machine, but also the connections between the individual label holders. In some embodiments, the severing of the connections may also take place in a separate process.

The label holders can comprise or consist directly of an inscribable material. In another embodiment, the label holders may be designed in such a way that they enable an inscribable medium to be releasably or non-releasably attached.

### BRIEF DESCRIPTION OF THE SEVERAL VIEWS OF THE DRAWINGS

Embodiments of the disclosure will be explained in more detail with reference to the drawings.

FIG. 1 shows a perspective view of two crimp contacts which are part of an endless contact tape.

FIG. 2 shows the crimp contacts as per FIG. 1 in a state after the attachment of label holders, the label holders in turn forming an endless tape.

FIGS. 3 and 4 show enlarged perspective partial views of the contact tape as per FIG. 2, for the purpose of illustrating a riveting process for connecting the label holders to the crimp contacts.

FIG. 5 shows the contact tape and the label holders conjointly with a stripped end of an electrically conducting wire.

FIG. 6 shows an enlarged perspective partial view of a crimp contact, of the associated label holder and of the wire.

FIG. 7 shows the crimp contact, the label holder, and the wire after crimping.

FIG. 8 shows the crimp contact with the label holder and an associated cover part.

FIG. 9 shows a view of a labeled wire which is connected to a plug connector with the aid of the crimp contact.

### DETAILED DESCRIPTION

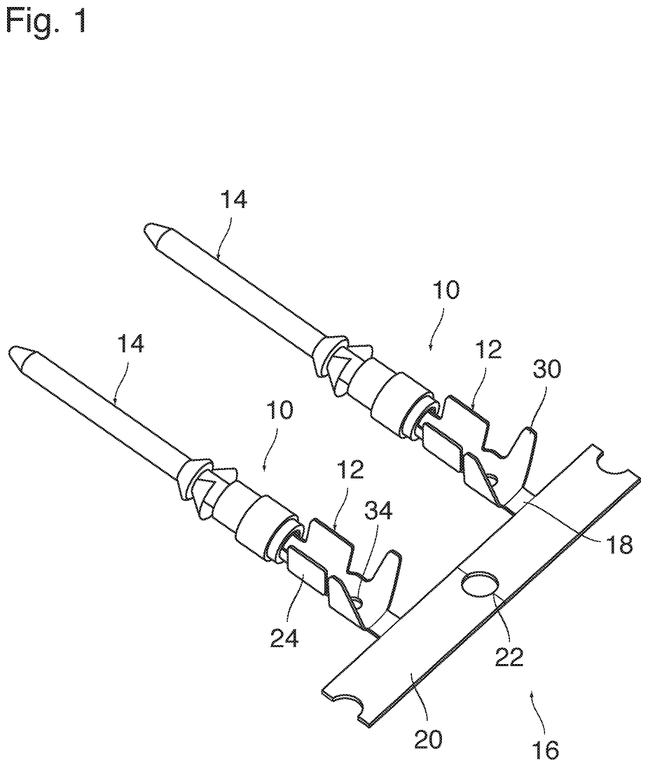

Shown in FIG. 1 are two hybrid contacts 10 which are in each case formed by a crimp contact 12 and a contact pin 14, the contact pin 14 already mechanically and electrically connected to the crimp contact 12.

While the contact pins 14 are turned parts made of metal, the crimp contacts 12 are formed by stamped parts which are made of sheet metal, and in the state shown in FIG. 1 are still part of a contact tape 16 that forms a fundamentally endless sequence of crimp contacts 12 which are connected to a carrier tape 20 by way of predetermined breaking points 18. The carrier tape 20, between each two successive crimp contacts 12, has a through opening 22 for transporting the tape.

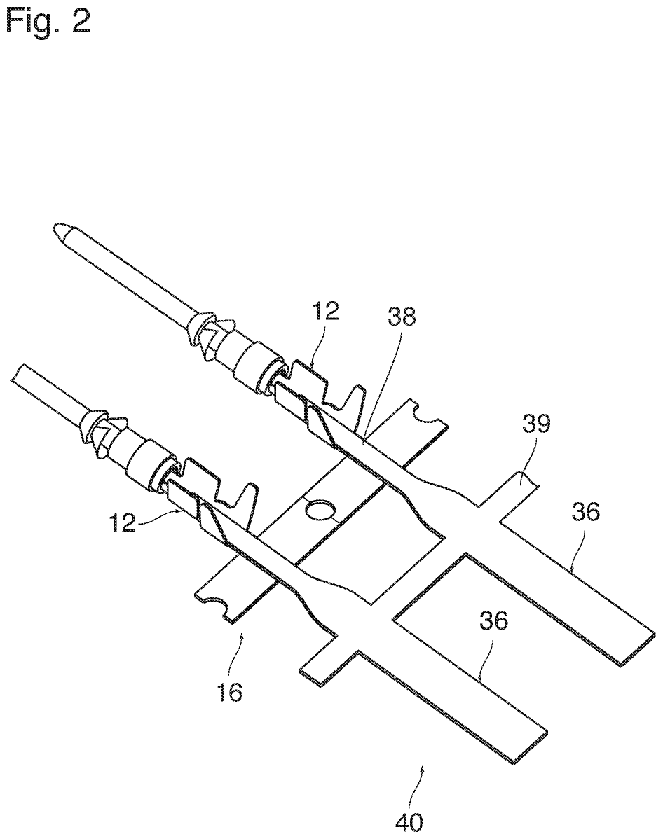

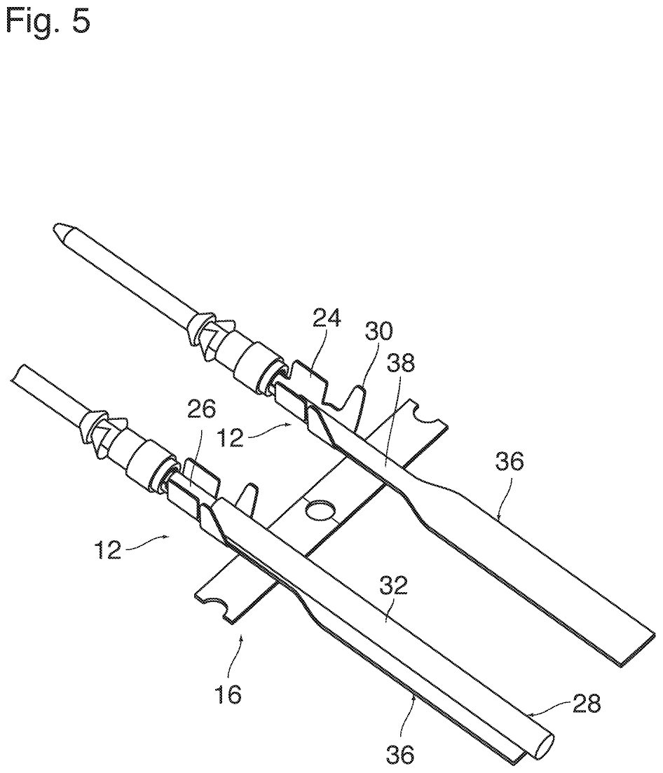

Each crimp contact 12 forms two crimping wings 24 which in the state shown in FIG. 1 are spread apart in a V-shaped manner and later, in an automatic crimping machine, are closed about a stripped end 26 (FIG. 5) of an electrically conducting wire 28. Two strain relief wings 30 are disposed so as to be adjacent to the crimping wings 24, the strain relief wings 30 in FIG. 1 being likewise spread apart in a V-shaped manner and later, in an automatic crimping machine, being closed about an insulation 32 (FIG. 5) of the electrically conducting wire 28. Formed in the base of each crimp contact 12, for example, so as to be centric between the strain relief wings 30, is at least one rivet hole 34 which serves for fastening a label holder 36, shown in FIG. 2, to the crimp contact 12.

As shown in FIG. 2, the label holders 36 are in each case designed as flat, elongate strips which taper at one end so as to form a fastening tab 38 that protrudes into the crimp contact 12. The label holders 36 are also connected to one another by a carrier tape 39, and are part of an endless tape 40 of flexible plastics material which extends parallel to the contact tape 16.

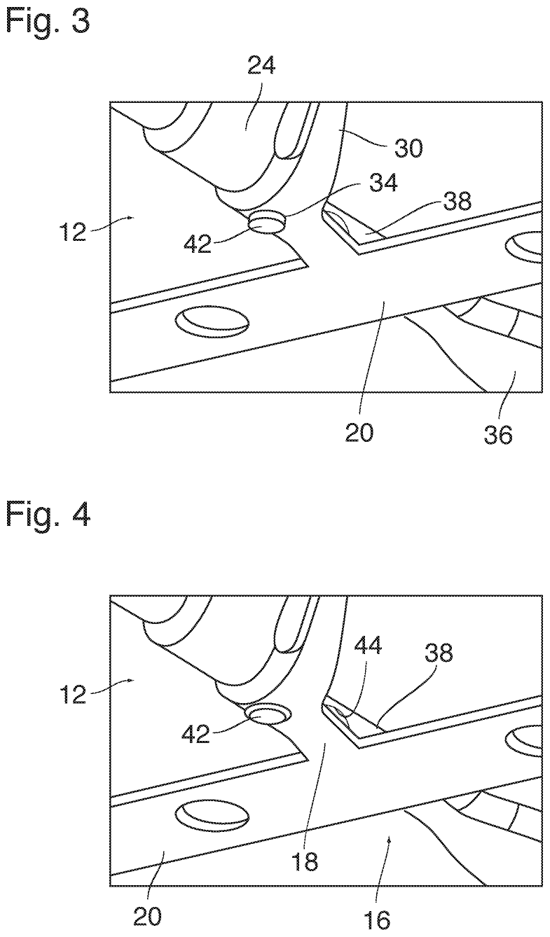

Illustrated in FIG. 3 is one of the crimp contacts 12 in an enlarged view from below. To be seen are a portion of the carrier tape 20 and one of the crimping wings 24 and one of the strain relief wings 30 of the crimp contact 12, and part of the label holder 36 and part of the fastening tab 38 bearing on the base of the crimp contact. A rivet head 42 that penetrates the rivet hole 34 is integrally molded on the lower side of this fastening tab. FIG. 3 shows the rivet head 42 in the non-compressed state, while FIG. 4 shows the state after compression of the rivet head 42. It can be seen in FIG. 4 that the fastening tab 38 on the lower side thereof, level with the predetermined breaking point 18 of the contact tape, has a recess 44. This recess 44 prevents that the tools, by way of which the crimp contact 12 is later separated from the carrier tape 20 at the predetermined breaking point 18, come into contact with the fastening tab 38 and damage the fastening tab 38.

FIG. 5 shows the contact tape 16 in a state in which the connections between the individual label holders 36 have already been severed. The wire 28 has also already been placed in one of the two crimp contacts 12. This wire 28, by way of its insulation 32, bears on the label holder 36.

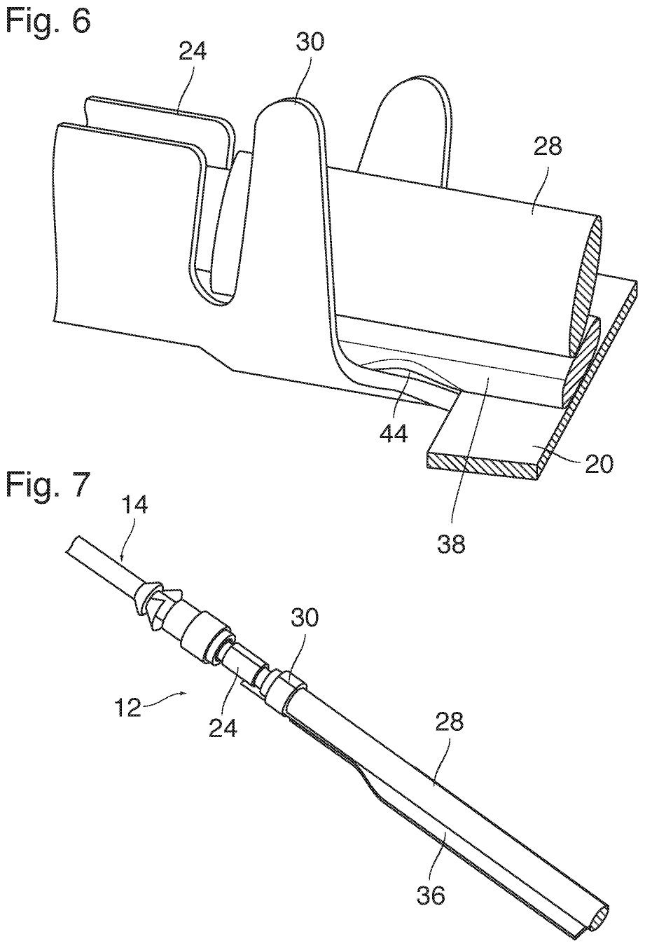

It can be seen more clearly in FIG. 6 how the stripped end of the wire 28 and the fastening tab 38 of the label holder bear on the base of the crimp contact 12. The recess 44 on the lower side of the fastening tab 38 can also be seen more clearly here.

In this state, with the respective wire 28 placed therein, the crimp contacts 12 are in each case supplied to an automatic crimping machine in which the crimping wings 24 are bent back over the stripped end 26 of the wire 28, and the strain relief wings 30 are bent back over the insulation 32 of the wire 28, so that the conductor as well as the insulation of the wire 28 are fixed in a tension-resistant manner by way of a crimp connection with the crimping wings 24 and strain relief wings 30. The placing of the wires 28, and optionally also the severing of the connections between the label holders 36, can take place automatically in an entry stage of the automatic crimping machine. The connections between the individual crimp contacts 12 are also automatically severed.

FIG. 7 shows one of the individual crimp contacts 12 with the wire 28 and the label holder 36 after completion of the crimping process. The crimping wings 24 and the strain relief wings 30 are henceforth tightly closed about the wire 28 and the fastening tab 38.

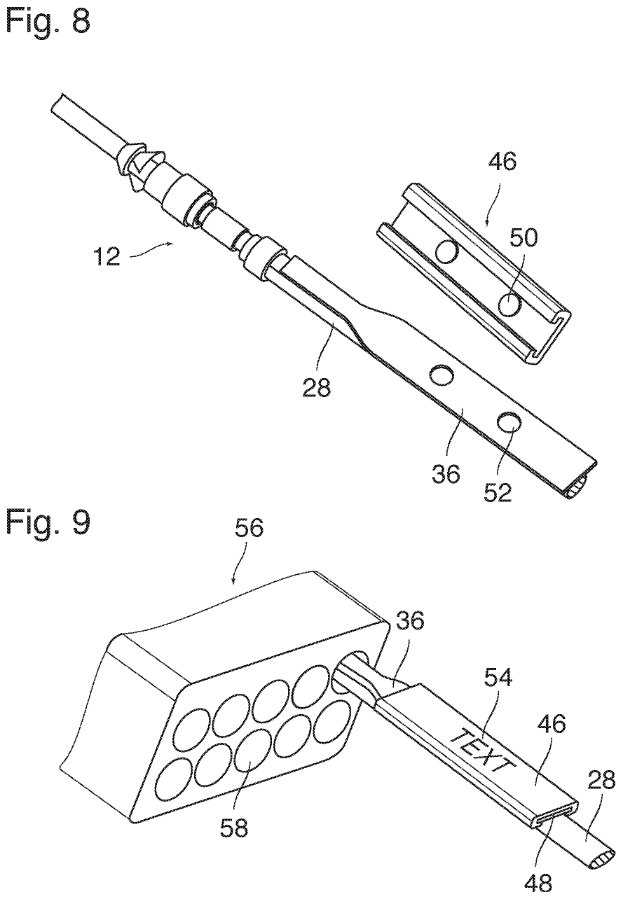

FIG. 8 shows the crimp contact 12 from FIG. 7 in a reversed position, so that the label holder 36 is now situated on an upper side. A transparent cover profile 46, which by way of its folded edges, can be pushed onto the label holder 36, so as to fix a printed paper strip 48 (FIG. 9) between the label holder 36 and the cover profile 46 and protect the paper strip 48 from contamination or damage.

As shown in FIG. 8, the cover profile 46 can have latching humps 50 on the inside, which latch into latching holes 52 of the label holder 36 once the cover profile 46 has been pushed onto the label holder 36, in this way fixing the cover profile 46 in the axial direction on the label holder 36.

As shown in FIG. 9, a marking 54 printed on the paper strip 48 is clearly visible through the transparent cover profile 46.

In FIG. 9, an end portion of a plug connector 56, which on an end side, has a plurality of contact openings 58 that are disposed in a regular pattern. Each contact opening 58 receives one plug socket which is not shown, and into which the contact pin 14 (FIG. 1) of the hybrid contact 10 is able to be plugged. The end of the wire 28 to which the hybrid contact 10 is fastened, and the fastening tab 38 of the label holder 36, then protrude from the contact opening 58, as can be seen in FIG. 9. The width of the label holders 36 is of such a size that the label holders 36 are disposed next to one another so as to be readily visible when each of the contact openings 58 receives one wire. The flexibility of the wires 28 and of the label holders 36 permits the upper layer of the wires 28 and of the label holders 36 to be bent upward somewhat in such a way that the markings in the lower layer also become visible.

The flexibility of the label holder 36 and of the wire 28 also permits the label holder 36 to be bent somewhat away from the wire 28 in order to push on or pull off the cover profile 46.

It will be appreciated that aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A method for attaching a label holder to an end of an electrically conducting wire provided with a crimp contact, the method comprising:
fastening a fastening tab of the label holder to the crimp contact before or during crimping of the crimp contact onto the end of the wire, wherein the fastening tab is composed of an electrically isolating material.

2. The method as claimed in claim 1, wherein the fastening tab is riveted to the crimp contact.

3. The method as claimed in claim 1, wherein the fastening tab, conjointly with the electrically conducting wire, is crimped into the crimp contact.

4. The method as claimed in claim 1, wherein a plurality of crimp contacts which are oriented so as to be mutually parallel are part of an endless contact tape, and wherein associated label holders are also connected by at least one connecting strip so as to form an endless tape, the endless contact tape and the endless tape of label holders are guided so as to be mutually parallel in such a manner that the fastening tabs of the label holders protrude in each case into a respective one of the crimp contacts, and that connections between individual crimp contacts and connections between the individual label holders are severed during or after crimping.

5. An endless tape, comprising:
a plurality of strip-shaped label holders arranged so as to be mutually parallel, wherein the plurality of strip-shaped label holders are connected to one another by a connecting strip and are configured to form the endless tape, and wherein one end of the strip-shaped label holders have in each case one fastening tab for fastening to a respective crimp contact.

6. A contact arrangement, comprising:
a crimp contact;
an electrically conducting wire; and
a label holder, wherein the label holder includes a fastening tab which is fastened to the crimp contact.

7. The contact arrangement as claimed in claim 6, wherein the fastening tab is riveted to the crimp contact.

8. The contact arrangement as claimed in claim 6, wherein the fastening tab is crimped into the crimp contact.

9. The contact arrangement as claimed in claim 6, wherein the crimp contact is connected mechanically and electrically to a pin-shaped contact element.

10. The contact arrangement as claimed in claim 9, further comprising a plug connector having a plurality of contact openings that lie next to one another and into which is insertable the pin-shaped contact element that is connected to the crimp contact and the label holder, wherein a width of the label holder that extends in a longitudinal direction of the wires is less than the spacing between the contact openings.
